(19) United States
(12) Patent Application Publication
(10) Pub. No.: US 2023/0010059 A1
(43) Pub. Date: Jan. 12, 2023

(54) Process for performing a pyrolysis of hydrocarbons in an indirectly heated rotary drum reactor

(71) Applicant: BASF SE, Ludwigshafen am Rhein (DE)

(72) Inventors: Frederik SCHEIFF, Ludwigshafen (DE); Dieter Flick, Ludwigshafen (DE); Lothar Seidemann, Ludwigshafen (DE); Jens Bernnat, Antwerpen (BE); Grigorios Kolios, Ludwigshafen (DE)

(73) Assignee: BASF SE, Ludwigshafen am Rhein (DE)

(21) Appl. No.: 17/757,084

(22) PCT Filed: Nov. 30, 2020
(86) PCT No.: PCT/EP2020/083837

§ 371 Date: Jun. 9, 2022

(30) Foreign Application Priority Data
Dec. 10, 2019 (EP) 19215001

(51) Int. Cl. B01J 6/00; B01J 19/08; B01J 19/28; B01J 8/08; B01J 8/10; B01J 8/12; C10G 9/24

(52) U.S. Cl. CPC B01J 6/008; B01J 8/10; B01J 8/12; B01J 8/087; B01J 19/28; B01J 19/087; C10G 9/24

(57) ABSTRACT

A process can be used for performing a pyrolysis of hydrocarbons in a rotary drum reactor at a temperature in the range of from 600 to 1800° C. The heat for the endothermic pyrolysis is provided by resistive heating of at least one particulate electrically conductive material introduced into said rotary drum reactor and moved through the rotary drum reactor with a flow of a hydrocarbon. The rotary drum reactor contains (A) an inner wall made of electrically insulated material, (B) a pressure-bearing outer wall, and (C) an electrical heating system attached to the inner wall and/or at least one integrated electrically conducting electrode pair. The at least one electrode pair is located at both ends of the inner wall of the rotary drum.

The present invention is directed towards a process for performing a pyrolysis of hydrocarbons in a rotary drum reactor at a temperature in the range of from 600 to 1800° C., whereas the heat for the endothermic pyrolysis is provided by resistive heating of at least one particulate electrically conductive material introduced into said rotary drum reactor and moved through the rotary drum reactor with a parallel or countercurrent flow of a hydrocarbon.

In addition, the present invention is directed to a rotary drum reactor containing the following elements:
(A) an inner wall made of electrically insulated material,
(B) a pressure-bearing outer wall
(C) an electrical heating system attached to the inner wall and/or at least one integrated electrically conducting electrode pair, wherein at least one electrode is located at each end (both ends) of the inner wall of the rotary drum.

Endothermic reactions pose a lot of requirements for the reaction technology. Particularly challenging are reactions that combine endothermic reaction enthalpy, high reaction temperatures, and particulate solids that exhibit a certain fragility. A key element of the reaction technology is the reactor.

An example of reactor for performing endothermic reactions at high temperature is the rotary kiln technology. In the kiln technology, the reaction good is typically exposed directly to hot gas stemming from the combustion of gas, oil, pulverized petroleum coke or pulverized coal. Several endothermic reactions, however, need to be performed in the absence of a combustion gas because that gas is detrimental to the desired product. For that reason, such reactions need to apply indirect heating.

In spite of many advantages of electrical heating:
(i) Heating output is substantially constant over the entire temperature range and not limited by the temperature of a heat carrier.
(ii) Omitting fuels and heat carriers simplifies the construction of the reactor and spares the control circuits for metering of the corresponding streams of matter in the periphery of the reaction zone. Moreover, contamination/dilution of the process streams by extraneous substances is ruled out. This increases the operational reliability of the reactor.
(iii) The heating is locally emission-free. When renewable, CO2-free sources are used, heating is even entirely emission-free,
the decisive and crucial disadvantage in the question of heating has to date been that electrical energy is costly compared to fossil energy carriers. However, this disadvantage should be eliminated in the next few years owing to the energy transition called “Energiewende”, the transformation to renewable energies.

Moreover, there has to date been a lack of a reactor concepts for efficient introduction and for uniform distribution of the electrical energy in packed reactors for performance of endothermic gas phase or gas-solid reactions at high temperatures.

There is currently no commercially operated, electrically heated, packed reactor for carrying out endothermic reactions in the gas phase or of gas-solid reactions.

Most conventionally operated high-temperature processes are heated by fired furnaces. These processes depend on energy export in order to work economically; only about 50% of the heat generated in the process is actually utilized for the endothermic reaction. Complete thermal integration is thus still a far-off aim.

It was accordingly an object of the present invention to demonstrate an electrically heated rotary drum reactor concept. A further object was to uniform the heating of the particulate material across the radius of the rotating tube. It was a further object to present a packed rotary drum reactor having maximum thermal integration.

It was therefore a further objective of the present invention to provide a process by which particulate materials may be reacted in an endothermic reaction. It was further an objective to provide a reactor for performing such a process.

Accordingly, the process for performing a pyrolysis of hydrocarbons in a rotary drum reactor at a temperature in the range of from 600 to 1800° C. has been found, whereas the heat for the endothermic pyrolysis is provided by resistive heating of at least one particulate electrically conductive material introduced into said rotary drum reactor and moved through the rotary drum reactor with a parallel or countercurrent flow of a hydrocarbon.

Preferably said rotary drum reactor contains of the following elements:
(A) an inner wall made of electrically insulated material,
(B) a pressure-bearing outer wall
(C) an electrical heating system attached to the inner wall and/or at least one integrated electrically conducting electrode pair (two integrated electrically conducting electrodes), wherein at least one electrode is located at both ends of the inner wall (also tube) of the rotary drum.

“Electrically insulated” in the present application is understood to mean an ohmic resistance of greater than 1 kΩ, preferably greater than 100 kΩ, especially greater than 1 MΩ, between the material packing and the inner wall of the rotating drum of the reactor, measured according to standard DIN VDE 0100-600:2017-06 (release date 2017-06). The inner wall is made of electrically insulated material to avoid any risk of electrical short circuit.

Material Packing (also named particulate electrically conductive material or solid material): Advantageously, a potential difference (voltage) of 1 volt to 10000 volts, preferably of 10 volts to 5000 volts, more preferably of 50 volts to 1000 volts, is applied between the at least two electrodes located at both ends of the inner wall (tube) of the rotary drum, the material inlet electrode and the material outlet electrode (also called upper and the lower electrode). The electrical field strength between the electrodes is advantageously between 1 V/m and 100000 V/m, preferably between 10 V/m and 10000 V/m, further preferably between 50 V/m and 5000 V/m, especially between 100 V/m and 1000 V/m.

The specific electrical conductivity of the material packing of the particulate electrically conductive material (also called solid-state packing) is advantageously from 0.001 S/cm to 100 S/cm, preferably from 0.01 S/cm to 10 S/cm, especially from 0.05 S/cm to 5 S/cm.

This advantageously results in an electrical current density in the solid-state packing of 0.01 A/cm² to 100 A/cm², preferably from 0.05 A/cm² to 50 A/cm², especially from 0.1 A/cm² to 10 A/cm².

The solid particles are advantageously thermally stable within the range from 500 to 2000° C., preferably 1000 to 1800° C., further preferably 1300 to 1800° C., more preferably 1500 to 1800° C., especially 1600 to 1800° C.

The solid particles are advantageously electrically conductive within the range between 10 S/cm and 10⁵ S/cm.

Useful thermally stable solid particles, especially for methane pyrolysis, advantageously include carbonaceous materials, e.g. coke, silicon carbide and boron carbide. Optionally, the solid particles have been coated with catalytic materials. These heat carrier materials may have a different expandability compared with the carbon deposited thereon.

The solid particles have a regular and/or irregular geometric shape. Regular-shaped particles are advantageously spherical or cylindrical.

The solid particles advantageously have a grain size, i.e. an equivalent diameter determinable by sieving with a particular mesh size, of 0.05 to 100 mm, preferably 0.1 to 50 mm, further preferably 0.2 to 10 mm, further preferably 0.5 to 10 mm, further preferably 0.5 to 5 mm, especially 0.8 to 4 mm.

Also advantageous is the use of carbonaceous material, for example in granular form. A carbonaceous granular material in the present invention is understood to mean a material that advantageously consists of solid grains having at least 50% by weight, preferably at least 80% by weight, further preferably at least 90% by weight, of carbon, especially at least 90% by weight of carbon.

It is possible to use a multitude of different carbonaceous granular materials in the process of the invention. A granular material of this kind may, for example, consist predominantly of charcoal, coke, coke breeze and/or mixtures thereof. In addition, the carbonaceous granular material may comprise 0% to 15% by weight, based on the total mass of the granular material, preferably 0% to 5% by weight, of metal, metal oxide and/or ceramic.

Reactor: The drum reactor, preferably rotating along a horizontal axis having an angle between 0 to 10°, of the invention advantageously comprises a random bed of solid particles of electrically conductive material. The bed may be homogeneous or structured over its length/height, preferably by internal(s) attached to the inner wall of said rotating drum. A homogeneous bed may advantageously be a fixed bed, a moving bed or a fluidized bed, especially a moving bed.

The rotating drum reactor is advantageously divided into multiple zones.

Advantageously, the following are arranged from the outlet of the particulate material upwards, e.g. from the entrance to the exit of the gaseous product stream: the entrance zone (1) the gas inlet (1a) and the outlet for the particles (1b), the heated reaction zone in the center with the electrical heating system (3), the exit zone (4), which is the exit for the gaseous product stream (4a) and the feed/entrance for the particle feed charge (4b).

In another embodiment, the following are arranged from the inlet of the gas and particulate material upwards, e.g. from the entrance to the exit of the gaseous product stream: the entrance zone (1) the gas inlet (1a) and the inlet for the particles (1b), the heated reaction zone in the center with the electrical heating system (3), the exit zone (4), which is the exit for the gaseous product stream (4a) and the outlet for the particle feed charge (4b).

The reaction zone is (i) the area along the inner wall the electrical heating system is attached to, or (ii) the area along the inner wall between the electrode pair located at the ends of the inner wall of the rotary drum. Therefore, the region of rotary drum reactor that is exposed to the heating system is the reaction zone of such rotary drum reactor.

Optionally, the entrance zone (1) of the gas inlet and/or the entrance/feed of the particulate material is equipped with a pair of electrodes (heat transfer zone (2)) between the gas inlet and the edge to the heated reaction zone with the electrical heating system (entrance heat transfer zone (2a)) and/or between the entrance/feed of the particulate material and the edge to the heated reaction zone with the electrical heating system (entrance heat transfer zone (2b)).

In one embodiment, the electric heating system contains at least of one integrated electrically conducting electrode pair,

In another embodiment, the electric heating system contains an electrical heating system attached to the inner wall.

Electrodes: If the electric heating system contains at least one integrated electrically conducting electrode pair, advantageously, the bottom side of the upper electrode and the top side of the lower electrode are horizontal over the entire drum reactor cross section. Consequently, the length of the heated zone, especially the zone between the electrodes, is advantageously uniform over the entire reactor cross section. The heated reactor cross section is advantageously from 0.005 m² to 200 m², preferably from 0.05 m² to 100 m², more preferably from 0.2 m² to 50 m², especially from 1 m² to 20 m². The length of the heated zone is advantageously between 0.1 m and 100 m, preferably between 0.2 m and 50 m, more preferably between 0.5 m and 20 m, especially between 1 m and 10 m. The ratio of the length to the equivalent diameter of the heated zone is advantageously from 0.01 to 100, preferably from 0.05 to 20, more preferably from 0.1 to 10, most preferably from 0.2 to 5.

The electrodes are advantageously positioned within the solid-state packing. The electrodes may rotate or may not rotate (static).

The vertical distance between the feed for the particle stream (6) and the upper edge of the solid-state packing is advantageously 50 mm to 5000 mm, preferably between 100 mm and 3000 mm, more preferably between 20 mm and 2000 mm.

The electrodes may take on all forms known to those skilled in the art. By way of example, the electrodes take the form of a grid or of rods.

When rods are used, electrode rods that run to a point are particularly advantageous. Preferably, the upper and lower electrode rods run to a point on the side toward the heated zone. The tip may be conical or wedge-shaped. Correspondingly, the end of the rod may take the form of a dot or a line. By contrast with US 3,157,468 or US 7,288,503, for example, the rod electrodes are connected to the entrance and/or exit zone, e.g. the reactor hood, in an electrically conductive manner and are jointly supplied with electrical power via the entrance and/or exit zone, e.g. the reactor hood.

A fixed bearing is understood to mean the connection of a rigid body to its environment, with the aid of which relative movement between the body and its environment is prevented in any direction.

For example, the grid in the form of spokes is advantageously formed from bars arranged in a star shape that are suspended on the entrance and/or exit zone, e.g. a reactor hood, or a connecting element secured thereon. As well as the term “bars”, the prior art also uses the terms “spoke”, “carrier” or “rail”.

In a further configuration, the grid in the form of spokes is advantageously formed from bars arranged in a star shape that are suspended in the entrance and/or exit zone, e.g. a reactor hood and bear electrode plates that proceed orthogonally therefrom. Beside the term “electrode plate”, the prior art also uses the terms “wing”, “fin”, “side rail” or “side bar”.

In a further configuration, the grid is advantageously formed from concentric rings that are connected via radial bars. According to the definition in DE 69917761 T2 [0004], the grid shape is “fractally scaled”.

The electrodes, i.e. electrode bars and electrode plates, divide the cross section of the reaction zone into grid cells. The grid cells are characterized by the following parameters: open cross section, equivalent diameter, out-of-roundness and cross-sectional obstruction.

For further details: See WO 2019/145279 and references therein for further details.

Advantageously, an additional pair of electrodes is horizontally installed over the entrance heat transfer zone (2), preferably over the entire entrance heat transfer zone.

Material of the electrodes: The material of the electrodes, i.e. bars and electrode plates, is advantageously iron, cast iron or a steel alloy, copper or a copper-base alloy, nickel or a nickel-base alloy, a refractory metal or an alloy based on refractory metals and/or an electrically conductive ceramic. More particularly, the bars consist of a steel alloy, for example with materials number 1.0401, 1.4541, 1.4571, 1.4841, 1.4852, 1.4876 to DIN EN 10027-2 (release date 07–2015), of nickel-base alloys, for example with materials number 2.4816, 2.4642, of Ti, especially alloys with materials number 3.7025, 3.7035, 3.7164, 3.7165, 3.7194, 3.7235. Among the refractory metals, Zr, Hf, V, Nb, Ta, Cr, Mo, W or alloys thereof are particularly advantageous; preferably Mo, W and/or Nb or alloys thereof, especially molybdenum and tungsten or alloys thereof. In addition, bars may comprise ceramics such as silicon carbide and/or carbon, e.g. graphite, where the ceramics may be monolithic or fiber-reinforced composite materials (e.g. ceramic matrix compounds, CMC, e.g. carbon fiber composites, CFC).

Advantageously, the material of the electrodes is chosen depending on the application temperature. Steel is advantageously chosen within a temperature range from -50 to 1250° C., preferably -50 to 1000° C., further preferably -50 to 750° C., especially -50 to 500° C. Molybdenum is advantageously chosen within a temperature range from -50 to 1800° C., preferably -50 to 1400° C., especially -50 to 1300° C. Carbon fiber-reinforced carbon is advantageously chosen within a temperature range from -50 to 2000° C., preferably -50 to 1600° C., especially -50 to 1300° C.

In a specific application, the electrodes may also consist of multiple materials. When multiple materials are used, the electrode is advantageously divided into sections of different materials over its length. The selection of material in the different zones is advantageously guided by the following criteria: thermal stability, electrical conductivity, costs. Advantageously, the segments made of different materials are force-locked or cohesively bonded to one another. Advantageously, the connections between the segments are smooth.

Electrodes may advantageously be executed as solid electrodes or as hollow electrodes. In the case of solid electrodes, advantageously, according to the design, the electrode rods, the electrode bars and/or the electrode plates are solid bodies. In the case of hollow electrodes, advantageously, according to the design, the electrode rods, the electrode bars and/or the electrode plates are hollow bodies. The cavities within the electrodes may advantageously form channels utilizable for introduction of gaseous streams into the reaction zone or for removal of gaseous streams from the reaction zone. The walls of the hollow electrodes are advantageously formed from slotted sheets, perforated sheets, expanded metal grids or mesh weaves.

The grid in the form of spokes advantageously has electrode bars, advantageously 2 to 30 electrode bars, preferably 3 to 24 electrode bars, especially 4 to 18 electrode bars. On each of these electrode bars are advantageously secured 1 to 100 electrode plates, preferably 2 to 50, especially 4 to 20.

The length of the bars is advantageously between 1 cm and 1000 cm, preferably between 10 cm and 500 cm, especially between 30 cm and 300 cm. The height of the bars is advantageously between 1 cm and 200 cm, preferably between 5 cm and 100 cm, especially between 10 cm and 50 cm. The thickness of the bars (at the thickest point) is advantageously between 0.1 mm and 200 mm, preferably between 1 mm and 100 mm.

The side profile of the bars and of the electrode plates is advantageously rectangular, trapezoidal or triangular, although other geometric forms, for example rounded forms, are also conceivable. Advantageously, the lower edges of the bars and plates in the upper electrode and the upper edges of the bars and plates in the lower electrode are horizontal.

The cross section of the bars and the electrode plates is advantageously lenticular, diamond shaped or hexagonal. In this case, the upper end and the lower end of the bars advantageously run to a point. The thickness of a bar or electrode plate at the upper end and at the lower end (at the tips) is advantageously between 0.001 mm and 10 mm, preferably between 0.001 mm and 5 mm, especially between 0.001 mm and 1 mm.

The profile of the bars and the electrode plates in top view is advantageously straight or in sawtooth form or wavy form. Wavy profiles are advantageously sinusoidal or rectangular. In the case of profiles in sawtooth form and wavy form, the width of a tooth or wave is advantageously 1 cm to 200 cm, preferably 1 cm to 100 cm, further preferably 1 cm to 50 cm; the height of the tooth or wave is advantageously 1 mm to 200 mm, preferably 1 mm to 100 mm, further preferably 1 mm to 50 mm.

The optional electrode plates are bonded to the bars and, in the top view of the reactor, are advantageously oriented orthogonally to the bars. Advantageously, the electrode plates are bonded to the bar either in the middle or at one end of the electrode plates. Advantageously, the contact surface between electrode plate and bar constitutes the sole fixed bearing for the positioning of an electrode plate. Correspondingly, the two ends are free or one end is free, meaning that it has no fixed connection to other electrode plates or other bars. As a result, the electrode plates can deform in a stress-free manner by thermal expansion.

The distance between the adjacent electrode plates on a bar is advantageously 1 to 2000 mm, preferably 5 to 1000 mm, especially 10 to 500 mm.

Contacting the electrodes: The gas exit (upper) and gas entrance (lower) sections of the reactor housing advantageously each form the contacts for the upper and lower electrodes. The electrodes are advantageously contact-connected via the end sections of the reactor housing, also called reactor gaskets. The reactor gaskets advantageously have one or more electrical connections, preferably one to three connections, on the outside.

Advantageously, the temperature at the contact surface between the upper apparatus section and the connecting element is advantageously less than 600° C., preferably less than 450° C., more preferably less than 150° C., advantageously in the range of 0 to 600° C., preferably 10 to 450° C.

Reactor: The pressure-bearing rotating drum reactor shell advantageously consists of a gas exit (upper) reactor section, a middle reactor section and a gas entrance (lower) reactor section. Preferred materials for the reactor shell are steel alloys, for example with materials number 1.4541, 1.4571. The preferred specific conductivity of the upper and/or lower apparatus section is advantageously between 10⁵ S/m and 10⁸ S/m, preferably between 0.5 × 10⁶ S/m and 0.5 × 10⁸ S/m. The specific ohmic resistivity of the outer pressure-bearing reactor shell is advantageously between 10⁻⁸ Ωm and 10⁻⁵ Ωm, preferably between 210⁻⁷ Ωm and 210⁻⁶ Ωm.

The gas exit (upper) reactor section, advantageously has the following connections: electrical supply, at least one solids inlet and optionally a distributor (for example in the form of a cone distributor), bushings, one or more outlets for a product stream, advantageously for a gaseous product stream, feeds for sensors, for example for temperature measurement, fill level measurement, concentration measurement, pressure measurement.

The gas entrance (lower) reactor section, advantageously has the following connections: the exit cone for a product stream, advantageously for a solid product stream, the electrical supply, at least one inlet for reactant streams, preferably for gaseous reactant streams, bushings, feeds for sensors, for example for temperature measurement, concentration measurement, pressure measurement.

The middle reactor section is advantageously electrically insulated with respect to the two hoods and/or the electrodes. The inner wall of the middle reactor section is made of electrically insulated material.

The middle reactor section is advantageously cylindrical or prismatic. This region is advantageously electrically insulated and thermally stable up to about 2000° C., preferably up to about 1700° C., preferably up to about 1400° C., preferably up to about 1200° C. This section defines the length of the heated zone. The length of the middle reactor section is advantageously between 0.25 m and 100 m, preferably between 0.5 m and 50 m, more preferably between 0.75 m and 20 m, especially between 1 m and 10 m.

Electrical heating system attached to the inner wall: The heating system (B) is electric and in one embodiment the heating system is preferably attached to the inner wall of the rotary drum reactor. The heating system may be selected from heating selected from resistance heating, inductive heating, and micro-wave heating.

In one embodiment of the present invention, the heating system covers the inner surface of the inner drum to the extent of 70 to 100% of the inner surface of the inner drum.

In one embodiment of the present invention, the heating system is attached to the inner wall through bolts or screws. In another embodiment of the present invention, the heating system is drum shaped and has the same outer diameter as the inner diameter of the inner drum, upon heating and thermal expansion, the heating system is pressed to the wall of the drum due to the thermal expansion.

The electrical insulation assumes the functions of: (i) insulating the entrance and exit zone from the side wall of the reactor, i.e. the middle section of the reactor shell, and (ii) insulating the bed from the side wall of the reactor.

For example, refractory rocks/lining can advantageously be used for insulating walls. Typically, refractory rocks advantageously comprising aluminum oxide, zirconium oxide and mixed oxides of aluminum, magnesium, chromium, silicon are used for the electrically insulating lining (see, for example, thesis by Patrick Gehre: Korrosions- und thermoschockbestandige Feuerfestmate rialien für Flugstromvergasungsanlagen auf Al203-Basis-Werkstoffentwicklung und Korrosion suntersuchungen [Corrosion- and Thermal Shock-Resistant Refractory Materials for Entrained Flow Gasification Plants Based on Al203 - Material Development and Corrosion Studies]. (TU Freiberg, 2013)).

Heat integration: The reactor of the invention offers advantageous features for the implementation of a heat-integrated mode of operation for endothermic high-temperature processes. These features are in particular (i) the countercurrent regime between a stream of solid-state particles and a gas stream, and (ii) the adjustment of the position of the heated zone within the reaction zone, which results in a heat transfer zone for reverse heat exchange between the hot product gas and the cold stream of solid-state particles at the upper end and a heat transfer zone for reverse heat exchange between the solid product stream and the cold gas feed at the lower end.

The efficiency of thermal integration is achieved by the minimization of heat transfer resistance between the gas and the solid-state packing by virtue of a favorable ratio of the heat capacity flow rates of the gaseous reaction media and solid reaction media in the heat transfer zones. A measure of the efficiency of the thermal integration is the efficiency of thermal integration: η = (reaction zone temperature - gas exit temperature of the main stream)/(reaction zone temperature - solids inlet temperature).

The efficiency of thermal integration is advantageously greater than 60%, preferably greater than 65%, further preferably greater than 70%, further preferably greater than 80%, further preferably greater than 90%, especially greater than 95%. The efficiency of thermal integration is advantageously in the range from 60% to 99.5%.

The length of the heat transfer unit is determined predominantly by the parameters of (i) properties of the bulk particles such as particle size, thermal conductivity, coefficient of emission, (ii) properties of the gas phase such as conductivity, and (iii) operating conditions such as pressure, temperature, throughput.

The heat transfer resistance in the heat exchange between the gas and the solid-state packing in the heat transfer zones advantageously has a length of the transfer units or height-of-transfer units (HTU) of 0.01 to 5 m, preferably 0.02 to 3 m, more preferably of 0.05 to 2 m, especially of 0.1 to 1 m. The definition of HTU is adopted from https://elib.uni-stuttgart.de/bitstream/11682/2350/⅟docu_FU.pdf on page 74.

The heat capacity flow rate is the product of mass flow rate and specific heat capacity of a stream of matter. Advantageously, the ratio of the heat capacity flow rates between the gaseous process stream and the solid process stream is from 0.5 to 2, preferably from 0.75 to 1.5, more preferably from 0.85 to 1.2, especially from 0.9 to 1.1. The ratio of the heat capacity flow rates is adjusted via the feed streams and optionally via the side feeding or side withdrawal of partial currents.

At the upper end of the reaction zone, especially at the upper edge of the solid-state packing, the difference between the exit temperature of the gaseous product stream and the feed stream of solid-state particles is advantageously from 0 K to 500 K, preferably from 0 K to 300 K, further preferably from 0 K to 200 K, especially from 0 K to 100 K.

At the lower end of the reaction zone, especially at the point where the solid product stream is drawn off from the reactor, the difference between the exit temperature of the solid product stream and the gaseous feed stream is advantageously from 0 K to 500 K, preferably from 0 K to 300 K, further preferably from 0 K to 200 K, especially from 0 K to 100 K.

Pyrolysis of hydrocarbons: The inventive process is preferably performed at temperature in the range of from 600 to 1800° C., more preferred in the range of from 800 to 1600° C., more preferred in the range of from 900 to 1500° C., even more preferred in the range of from 1000 to 1500° C., even more preferred in the range of from 1100 to 1500° C., even more preferred in the range of from 1200 to 1400° C.

The preferred reaction is the methane pyrolysis. The process of the invention is suitable more particularly for the pyrolysis of natural gas, where the methane fraction in the natural gas, depending on the natural gas deposit, is typically between 75% and 99% of the molar fraction.

The inventive process is carried out in a rotary drum reactor. Rotary drum reactors in the context of the present invention are vessels that rotate along a longitudinal axis that may be horizontal or tilted by 0.1 to 90 degrees and that have a length to diameter ratio in the range of from 0.1 to 20, preferably from 0.5 to 20.

In one embodiment of the present invention, rotary drum reactors may have a length in the range of from 1 to 20 meters, preferably 2 to 10 meters.

In one embodiment of the present invention, rotary drum reactors in the context of the present invention are cylindrically shaped, preferably as right cylinders.

In one embodiment of the present invention, the rotary drum reactor is operated with 0.01 to 20 rounds per minute, preferred are 1 to 10 rounds per minute, and, in each case, continuously or in intervals. When operation in an interval mode is desired it is possible, for example, to stop the rotation after one to 5 rounds for one to 60 minutes, and then to again perform 1 to 5 rounds and again stop for 1 to 60 minutes, and so forth.

More details are described further down below.

The inventive process comprises the step of introducing a particulate solid into the rotary drum reactor and moving it through said rotary drum reactor with a flow of gas. The flow of gas may be co-current or counter-current, preferably counter-current.

In one embodiment of the present invention, the average residence time of the particulate solid is in the range of from 10 minutes to 12 hours, preferably 1 to 6 hours. In this context, the average residence time refers to the average residence time of the particulate material in the rotary drum reactor.

In one embodiment of the present invention, the average superficial velocity of the gas is in the range of from 0.005 m/s to 1 m/s, preferably 0.05 m/s to 0.5 m/s. With a higher superficial gas velocity, dust evolution may exceed a tolerable level.

In one embodiment of the present invention, the inventive process is performed at ambient pressure or ± 50 mbar, preferably ambient pressure up to 20 mbar above ambient pressure.

In another embodiment of the present invention, the inventive process is performed at a pressure preferably 1 to 50 bar, more preferably 5 to 20 bar, even more preferably 10 to 20 bar.

In one embodiment of the present invention, the filling level of said rotary drum reactor is in the range of from 50 to 100%, preferred are 70 to 90%. The filling level is determined under neglecting the voids between particles of particulate solid.

According to the present invention, the rotary drum reactor contains the following elements:
(A) an inner wall made of electrically insulated material,
(B) a pressure-bearing outer wall
(C) with an electrical heating system
   (i) attached to the inner wall (C1) and/or
   (ii) at least one integrated electrically conducting electrode pair (C2)(two integrated electrically conducting electrodes), wherein at least one electrode is located at both ends of the inner wall (tube) of the rotary drum.

Optionally, internal(s) are attached to the inner wall of said rotating drum (D).

Rotary drum reactors further contain one or more internals, passive movement devices for the particulate material, for example 2 to 3. Such internal(s) are attached to the inner wall, or to the front and end surfaces of a non-rotating part of said rotating drum reactor.

Internal(s) may be selected from baffles, plough shares, blades or shovels. Internals may expand entirely from the wall to the center of the rotary drum or they may expand partially from the wall to center of the rotating drum. Preferably, from 1 to 10 internals are distributed along the axis of the rotating drum and from 1 to 10 internals are distributed along the circumference of the rotating drum. In total, from 2 to 100 internals may be distributed inside the rotating drum, preferably, and preferably from 4 to 20 internals may be distributed inside the rotating drum in a symmetric orientation.

In one embodiment of the present invention, the length of the drum is from 0.5 to 20 m, preferably from 1 to 10 m.

The rotary drum reactor is preferably a double-wall drum.

In one embodiment of the present invention, both walls, the inner and the outer wall rotates. In this case, the material of the inner walls is preferably made of refractory bricks/lining, ceramic materials or ceramic matrix composites and the material of the outer wall are preferable steel alloys, for example with materials number 1.4541, 1.4571. The design and the material is known in the art, e.g. cement production; the outer temperature of the outer wall should be less than 250° C.

In another embodiment of the present invention, the inner wall rotates and the outer wall does not rotate (the outer wall is static). In this case, the material of the inner wall is preferably a ceramic or a ceramic matrix composite (OCMC or OCMC-Hybride, see WO 2016/184776, WO 2019/145279, PCT/EP2019/071031 and references therein and description below) or an alloy selected from steels and nickel-based alloys and cobalt refractory alloys, or a metal selected from tungsten, molybdenum, iron, and nickel and the material of the outer wall are preferable steel alloys, for example with materials number 1.4541, 1.4571. The design is known in the art, e.g. WO 2016/184776, WO 2019/145279, PCT/EP2019/071031; the outer temperature of the outer wall should be less than 250° C. and the inner wall should be reasonable stable in view of bending stress.

Each wall may have a thickness in the range of from 5 to 30 mm, preferred between 7 and 20 mm. The inner and the outer wall may have the same or different thicknesses. Preferably, the outer wall is 1.5 to 3 times thicker than the inner wall.

The thickness of the outer wall needs to be designed according to the maximum temperature outside the drum and according to the pressure of the reaction.

In one embodiment of the present invention, the distance between the outer and the inner wall is in the range of from 1 to 20 cm, preferably 5 to 10 cm, determined at ambient temperature. The distance is an average value.

The distance between the inner wall and the outer wall, the pressure bearing wall, may optionally be purged by a directed gas stream. The purge gas used is advantageously CO2, H2O, N2, H2, N2, lean air (N2-diluted air) and/or Ar. The purge gas stream is advantageously introduced in an annular manner via the upper dome and drawn off via the baseplate of the lining. Alternatively, the purge gas stream is introduced in an annular manner via the baseplate of the lining and drawn off via the dome. The purge gas stream advantageously forms a gas curtain that separates the reaction zone from the pressure-rated reactor shell. This can prevent the formation of deposits on the inside of the pressure-rated reactor shell; in addition, the pressure-rated shell can be cooled.

A ceramic matrix composite contains ceramic fibers, and it additionally comprises a ceramic matrix material. The fibers are in an ordered or non-ordered orientation, for example 0°/90° layup or randomly criss-cross. Ceramic fibers and ceramic matrix material may have identical or different chemical compositions. In the context of the present invention, ceramic matrix composites comprise fibers embedded in ceramic oxide or non-oxide matrices. The bonding forces between the fibers and the matrix are comparatively low. Oxide matrix materials such as aluminum oxide are preferably in particulate form.

Ceramic fibers and ceramic matrix materials may each be selected from oxide and non-oxide ceramics. Examples of non-oxide ceramics are carbides and borides and nitrides. Particular examples of non-oxide ceramics are silicon carbide, silicon boride, silicon nitride, silicon-boron nitride, hereinafter also referred to as SiBN, silicon carbon nitride, hereinafter also referred to as SiCN, and in particular combinations from SiC and Si3N4. Preferred are oxide ceramics, hereinafter also referred to as oxide-based ceramics. Oxide ceramics are oxides of at least one element selected from Be, Mg, Ca, Sr, Ba, rare earth metals, Ti, Zr, Hf, V, Nb, Ta, Cr, Mo, W, Mn, Fe, Co, Ni, Zn, B, Al, Ga, Si, Ge, Sn, Re, Ru, Os, Ir, In, Y, and mixtures of at least two of the foregoing. Oxide-based ceramics may be selected from doped ceramics, wherein one main component is doped with up to 1 molar % components other than the main component, and from reinforced ceramics, wherein one component is the main component, for example at least 50 molar %, and one or more further components - reinforcing components - are present in ranges from 1.1 to 25 molar %. Further examples are titanates and silicates. Titanates and silicates each may have a stoichiometric composition.

Preferred example of titanates is aluminum titanate. Preferred example of silicates is magnesium silicate.

Examples of reinforced ceramics are reinforced alumina and reinforced zirconia. They may contain two or more different reinforcement oxides and may thus be referred to as binary or ternary mixtures. The following binary and ternary mixtures are preferred: aluminum oxide reinforced with 1.1 to 25% by weight of one of the following: cerium oxide CeO₂, ytterbium oxide Yb₂O₃, magnesia (MgO), calcium oxide (CaO), scandium oxide (Sc₂O₃), zirconia (ZrO₂), yttrium oxide (Y₂O₃), boron oxide (B₂O₃), combinations from SiC and (AI₂O₃), or aluminum titanate. More preferred reinforcing components are B₂O₃, ZrO₂ and Y₂O₃.

Preferred zirconia-reinforced alumina is AI₂O₃ with from 10 to 20 mole-%ZrO₂. Preferred examples of reinforced zirconia are selected from ZrO₂ reinforced with from 10 to 20 mole-%CaO, in particular 16 mole-%, from 10 to 20 mole-% MgO, preferably 16 mole-%, or from 5 to 10 mole-% Y₂O₃, preferably 8 mole-%, or from 1 to 5 mole-%-% Y₂O₃, preferably 4 mole-%. An example of a preferred ternary mixture is 80 mole-% AI₂O₃, 18.4 mole-% ZrO₂ and 1.6 mole-% Y₂O₃.

Preferred fiber materials are oxide ceramic materials, carbide ceramic materials, nitride ceramic materials, SiBCN fibers, basalt, boron nitride, tungsten carbide, aluminum nitride, titania, barium titanate, lead zirconate-titanate and boron carbide. Even more preferred fiber materials are Al203, mullite, SiC, and ZrO₂ fibers.

In one embodiment the fibers are made from aluminum oxide, and the ceramic matrix composite comprises a ceramic matrix material selected from aluminum oxide, quartz, mullite, cordierite and combinations of at least two of the foregoing. Preferred is aluminum oxide.

Preferred are creep resistant fibers. In the context of the present invention, creep resistant fibers are fibers that exhibit minimum – or no – permanent elongation or other permanent deformation at temperatures up to 1,400° C.

In one embodiment of the present invention, ceramic fibers may have a diameter in the range of from 7 to 12 µm . Their length may be in the range of from 1 mm up to 1 km or even longer, so called endless fibers. In one embodiment, several fibers are combined with each other to yarns, rovings (German: Multifilamentgarn), textile strips, hoses, or the like. In a preferred embodiment of the present invention ceramic fibers used in the present invention have a tensile strength of at least 50 MPa, preferably at least 70 MPa, more preferably at least 100 MPa, and even more preferably at least 120 MPa. A maximum value of the tensile strength of ceramic fibers used in the present invention is 3,100 MPa or even 10,000 MPa. The tensile strength may be determined with a tensile tester. Typical measuring conditions are cross-head speeds of 1.2 to 1.3 cm/min, for example 1.27 cm/min, and 7.61 cm gauge.

In one embodiment of the present invention, the matrix is made from an oxide ceramic material or a carbide. Preferred oxide ceramic materials for the matrix are AI₂O₃, mullite, SiC, ZrO₂ and spinel, MgAl₂O₄.

Particularly preferred components are SiC/SiC, ZrO₂/ZrO₂, ZrO₂/Al₂O₃, Al₂O₃/ZrO₂, Al₂O₃/Al₂O₃ and mullite/mullite. The fiber material is in each foregoing case the first and the matrix the second material.

In one embodiment of the present invention, such ceramic matrix composite comprises 20 to 60 % by volume ceramic fiber.

Ceramic matric composites are porous. In many cases, the total solids content of such ceramic matrix composite is from 50 to 80% of the theoretical, the rest is air or gas due to the pores.

In one embodiment of the present invention, such ceramic matrix composite has a porosity in the range of from 20 % to 50 %; thus, such ceramic matrix composite is not gas tight in the sense of DIN 623-2.

In one embodiment of the present invention, the ceramic matrix composite comprises fibers from aluminum oxide and a ceramic selected from aluminum oxide, quartz, mullite, cordierite and combinations of at least two of the foregoing, for example aluminum oxide and mullite or aluminum oxide and cordierite. Even more preferably, the ceramic matrix composite comprises fibers from aluminum oxide and aluminum oxide ceramic.

Figure:

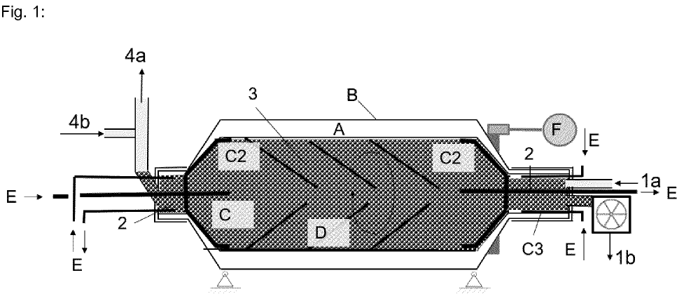

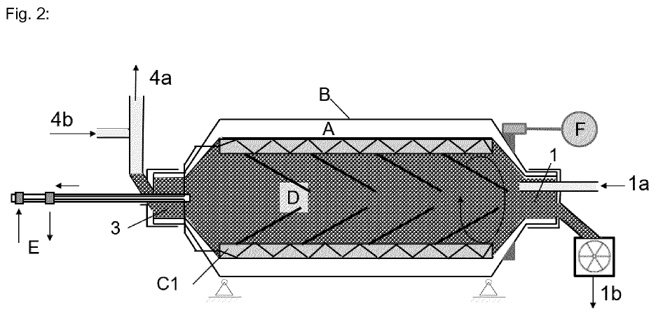

Description of the figures

| | |
|---|---|
| FIG. A | an inner wall made of electrically insulated material |
| FIG. B | a pressure-bearing outer wall |
| FIG. C | an electrical heating system |
| FIG. C1 | an electrical heating system attached to the inner wall |
| FIG. C2 | one integrated electrically conducting electrode pair |
| FIG. D | internal(s) are attached to the inner wall of said rotating drum |
| FIG. E | electrical power supply for heating / conducting electrodes |
| FIG. F | motor |
| FIG. 1 | entrance zone |
| FIG. 1a | gas inlet |
| FIG. 1b | outlet / discharge for the particulate material |
| FIG. 2 | preheating zone |
| FIG. 3 | heated reaction zone |
| FIG. 4a | gas exit zone / gas outlet |
| FIG. 4b | feed / entrance of the particulate material |

The figures show a rotating drum reactor with an electrically insulation inner wall (A) and a pressure-bearing outer drum wall (B), an electric heating systems (C, C2) and internal mixing elements (D), which are fixed at the internal wall of the drum. The rotation of the reactor, driven by a motor (F), allows a good mixing of the carbon particles and prevents agglomeration by coke deposition. Besides, the mentioned internal elements ensure the particle movement in axial direction and control the particle dwell time distribution.

The heat for endothermic pyrolysis of hydrocarbons is supplied in the reaction zone (3) or in preheating zones (2) by resistive heating of electrically conduction particles. Electricity (E) is introduced with an electrical heating system (C), which can be attached to the inner wall (C1) (see especially FIG. 2) and/or at least one integrated electrically conducting electrode pair, wherein one electrode is located at each end (both ends) of the inner wall of the rotary drum (C2) (see especially FIG. 1).

The hydrocarbon feed (1a, gas inlet) is guided in countercurrent flow to the particulate material and leaves the reactor on the other side (4a, gas outlet) in this embodiment. However, it can also be guided through the reactor in parallel to the particulate material. The particulate material is fed to the reactor (4b, feed of the particulate material), moved through the reactor and discharge on the other side (1b, discharge for the particulate material).

1. -16. (canceled)

17. A process, comprising:
performing an endothermic pyrolysis of at least one hydrocarbon in a rotary drum reactor at a temperature in a range of from 600 to 1800° C.,
wherein heat for the endothermic pyrolysis is provided by resistive heating of electrically conductive particulate material, wherein the electrically conductive particulate material is thermally stable within a range from 500 to 2000° C., and
wherein the electrically conductive particulate material is introduced into said rotary drum reactor and moved through the rotary drum reactor by one or more internals attached to an inner wall of the rotary drum reactor with a parallel or countercurrent flow of the at least one hydrocarbon.

18. The process according to claim 17, wherein the electrically conductive particulate material is moved through the rotary drum reactor with a countercurrent flow of the at least one hydrocarbon, and leaves the rotary drum reactor on an opposite side.

19. The process according to claim 17, wherein the electrically conductive particulate material has a grain size of 0.5 to 10 mm.

20. The process according to claim 17, wherein a filling level of said rotary drum reactor is in a range of from 50 to 100%.

21. The process according to claim 17, wherein carbon deposits on the electrically conductive particulate material.

22. The process according to claim 17, wherein the electrically conductive particulate material is a carbonaceous material.

23. The process according to claim 22, wherein the carbonaceous material is coke, silicon carbide, and/or boron carbide.

24. The process according to claim 17, wherein the at least one hydrocarbon is methane.

25. The process according to claim 17, wherein the temperature in the rotary drum reactor is in a range of from 1000 to 1500° C.

26. The process according to claim 17, wherein electricity for the resistive heating is introduced with an electrical heating system, which can be attached to the inner wall, and/or with at least one integrated electrically conducting electrode pair, wherein each electrode of the at least one integrated electrically conducting electrode pair is located at each end of the inner wall of the rotary drum reactor.

27. The process according to claim 26, wherein the at least one integrated electrically conducting electrode pair rotates along a longitudinal axis.

28. The process according to claim 26 wherein the at least one integrated electrically conducting electrode pair is static.

29. The process according to claim 17, wherein the rotary drum reactor contains the inner wall, which is made of an electrically insulated material, and a pressurebearing outer wall,
wherein both the inner wall and the outer wall rotate, and
wherein the electrically insulated material of the inner wall is ceramic or a ceramic matrix composite refractory brick, and the outer wall is made of a steel alloy.

30. The process according to claim 17, wherein the rotary drum reactor contains the inner wall, which is made of an electrically insulated material, and a pressurebearing outer wall,
wherein the inner wall rotates and the outer wall is static, and
wherein the electrically insulated material of the inner wall is a ceramic matrix composite or a material selected from the group consisting of a steel-based alloy, a nickelbased alloy, a cobalt refractory alloy, tungsten, molybdenum, iron, and nickel: and the outer wall is made of a steel alloy.

31. The process according to claim 17, wherein an average residence time of the electrically conductive particulate material is in a range of from 10 minutes to 12 hours.
